(19) United States
(12) Patent Application Publication
(10) Pub. No.: US 2013/0189655 A1
(43) Pub. Date: Jul. 25, 2013

(54) Pocket Tech

(71) Applicant: Stacy Lynne Boese, Cincinnati, OH (US)

(72) Inventor: Stacy Lynne Boese, Cincinnati, OH (US)

(21) Appl. No.: 13/355,784

(22) Filed: Jan. 23, 2012

(51) Int. Cl. G09B 19/00

(52) U.S. Cl. 434/219

(57) ABSTRACT

Pocket Tech is an Android app that will show MRI technologists how to scan every body part In MRI the tech must know how to image in all imaging planes, and this app will show them how to do it. Very useful for novice or even the experienced tech.

POCKET TECH IS A COMPUTER/ANDROID PROGRAM THAT SHOWS CUSTOMERS HOW TO SET UP SCANS FOR MRI MEDICAL IMAGING. IT CONTAINS A LIST OF HUMAN PARTS, OR AN IMAGE OF A HUMAN BODY WITH SELECTABLE BODY PARTS (MEANING THE USER CAN CHOOSE AN ELBOW, KNEE, BRAIN ETC.)

THE USER WILL PICK WHICH BODY PART THEY WANT TO SCAN. THE COMPUTER PROGRAM THEN SHOWS THE USER HOW TO SET UP THE SCANS.

THIS COMPUTER APPLICATION WILL ENSURE FACILITIES THAT THEIR MRI TECHNOLOGISTS ARE CAPABLE OF SCANNING ANY BODY PART ON ANY PATIENT. IF A TECH NEEDS TO DO AN MRI OF THE NECK, AND THEY HAVE NEVER DONE ONE, THEY CAN USE THIS COMPUTER PROGRAM TO INSTRUCT THEM ON HOW TO DO SO.

1. I am filing for a patent on the software program that teaches technologists how to set up the slices for an MRI scan. There appears to be no other software in existence that shows users how to scan each and every body part in all imaging planes, and what the images should look like. I wish I would have had this program to use from the beginning of my career. I could have excelled in my profession much earlier. I could have used this in so many instances. I would not have had to turn away patients because I didn't know how to scan a foot or a shoulder. If I could have shared this with other technologists, I would not have had to come in to work on all my days off because the staff techs did not know how to scan something. With Pocket Tech, even a novice technologist can scan even the most complicated exams, such as cardiac and breast MRI. This software invention will save employers money, as it saves the expenses of bringing in an experienced technologist to teach imaging planes. A vendor could utilize Pocket Tech as a selling point. If a company is going to purchase an MRI scanner, the vendor could offer Pocket Tech, the app that guarantees the technologists can scan anything
